(19) United States
(12) Patent Application Publication
(10) Pub. No.: US 2026/0334634 A1
(43) Pub. Date: Oct. 29, 2026

(54) LAST

(71) Applicant: MIZUNO CORPORATION, Osaka (JP)

(72) Inventors: Kenjiro KITA, Osaka (JP); Takao ODA, Osaka (JP); Takehiro TAGUCHI, Hyogo (JP); Issei TANAKA, Osaka (JP)

(73) Assignee: MIZUNO CORPORATION, Osaka (JP)

(21) Appl. No.: 19/728,004

(22) Filed: Jul. 1, 2026

Related U.S. Application Data
(63) Continuation of application No. 19/314,893, filed on Aug. 29, 2025.

(30) Foreign Application Priority Data
Sep. 6, 2024 (JP) 2024-153957

(51) Int. Cl. A43D 3/02; B33Y 80/00

(52) U.S. Cl. CPC A43D 3/02; B33Y 80/00

(57) ABSTRACT

It is enabled to easily and inexpensively provide a last in accordance with a foot shape and a request of each customer.

A last L includes a last body 10 having an outer surface shape corresponding to a predetermined standard foot model and an additional part 20 that changes the outer surface shape of the last L to a different shape from a shape of the standard foot model by fixing the additional part 20 to the last 10.

### CROSS-REFERENCE TO RELATED APPLICATION

This application claims priority to Japanese Patent Application No. 2024-153957 filed on Sep. 6, 2024, the entire disclosure of which is incorporated by reference herein.

### BACKGROUND

The present disclosure relates to a last used for manufacturing a shoe.

Conventionally, a technology for manufacturing custom-order shoes in accordance with a shape of a foot and a request (such as a fit feeling, a cushioning feeling, or the like) of each customer has been proposed (for example, see Patent Document 1 described below).

Patent Document 1 discloses a technology for changing a shape of a last used for forming an upper in accordance with a shape of a foot of each customer in order to manufacture custom-order shoes. Specifically, in Patent Document 1, the last is formed of a common part a shape and a position of which are unchangeable and first and second change parts shapes of which are unchangeable and positions of which are changeable. In the last, a toe part and a part extending from a midfoot to a heel part are of a common part, each of parts corresponding to a first toe tip and a fifth toe tip is a first position change part, and an instep part is a second position change part. Note that the second position change part is configured such that an angle with respect to the common part is changeable.

In Patent Document 1, a dimension of the midfoot of the last in a width direction is changed by changing a distance between the first position change parts of a left and right pair by a position adjusting mechanism. A height dimension of the midfoot of the last is changed by moving the second position change portion in an up-down direction by the position adjusting mechanism. Furthermore, a shape of the instep part of the last is changed by changing an angle of the second position change part with respect to the common part by the position adjusting mechanism. In Patent Document 1, the last is made to match with a foot shape of each customer by changing the dimension in the width direction and the height dimension of the midfoot and the shape of the instep of the last in a manner described above.

### CITATION LIST

### Patent Document

PATENT DOCUMENT 1: Japanese Patent Application No. 2021-171321

### SUMMARY

However, the last described above has a problem that a structure of the position adjusting mechanism that adjusts the positions of the first and second position change portions is complex and it takes time and labor to produce the position adjusting mechanism and significantly high production costs are required as compared to a normal last. Using the last described above, a width and an instep height around the midfoot can be adjusted, but a width of an entire portion of the last in a longitudinal direction and the shape cannot be adjusted, so that the last cannot be made to match with a foot shape of each customer or meet requests of each customer in some cases. Furthermore, in the last described above, a dimension is increased by moving a corresponding position change portion away from the common portion, so that a gap is generated between the common portion and the position change portion. In the last described above, the gap is filled by assembling a plate member in the gap, but even when the gap is filled with the plate member, a step is generated in an outer surface shape of the last and there is a probability that the generation of the step adversely affects forming of an upper.

In view of the foregoing, the present disclosure has been devised and it is therefore an object of the present disclosure to easily and inexpensively provide a last in accordance with a foot shape and a request of each customer.

In order to achieve the object described above, according to an aspect of the present disclosure, provided is a last used for forming an upper of a shoe, the last including a last body having an outer surface shape corresponding to a predetermined standard foot model, and an additional part that changes the outer surface shape of the last to a different shape from a shape of the standard foot model by fixing the additional part to the last body.

As used herein, the term “the predetermined standard foot model” refers to a relatively small foot model selected from various foot models (various foot models among which at least one of a size (foot length), a width (foot width), and a girth (foot girth) differs) assumed for each shoe size (for example, every 1 cm). For example, when, for a size 25 cm, four sizes, that is, 25 cm, 25.25 cm, 25.5 cm, and 25.75 cm, are assumed as different sizes and ten types of A, B, C, D, E, 2E, 3E, 4E, F, and G are assumed as types with different width and girth, a foot model which is selected from 40 types of foot models, an outer surface shape of which is changeable by fixing an additional part, and which is relatively small, that is, for example, a foot model a size of which is 25 cm and a width and a girth of which are of A (a foot model in a smallest size and with smallest width and girth), can be used as a standard foot model of 25 cm. Note that, as the standard foot model, a foot model in a smallest size and with smallest width and girth (a foot model in size 25 cm and of the type A) is preferable, but the standard foot model is not limited thereto. A relatively small foot model an outer surface shape of which can be changed by fixing an additional part can be selected from various foot models assumed for each shoe size and be used as the standard foot model. Note that the outer surface shape corresponding to a predetermined standard foot model includes not only a case where the outer surface shape of the last body is the same as that of the predetermined standard foot model but also a case where an outer surface shape deformed by changing a size, a width, and other dimensions thereof to increase functions of shoes, such as a fit feeling or the like, using the predetermined standard foot model as a reference is set as the outer surface shape of the last body.

According to the last of the first aspect, the outer surface shape of the last can be changed from that of the standard foot model by fixing the additional part to the last body having the outer surface shape corresponding to the predetermined standard foot model. By configuring the last in the above-described manner, it is made possible to configure, for various foot models assumed for each shoe size, a last corresponding to various foot models using a single last body not by producing lasts of the same number as the number of the foot models but by producing only the last body corresponding to the standard foot model and producing additional parts of multiple types. Therefore, as compared to a case where, for the various foot models assumed for each shoe size, lasts of the same number as the number of the foot models are produced, time and labor and production costs required for producing the last and a stock space for the last can be largely reduced. Accordingly, according to the first aspect, a last in accordance with a foot shape and a request of each customer can be easily and inexpensively provided.

According to a second aspect, in the first aspect, the additional part has an abutting surface extending along an outer surface of the last body and is configured to change the outer surface shape of the last to a different shape from that of the standard foot model by fixing the additional part to the last body in a state where the abutting surface abuts on the outer surface of the last body.

In the second aspect, the additional part changes the outer surface shape of the last by fixing the additional part such that the additional part abuts on the outer surface of the last body. According to the additional part, the outer surface shape of the last can be easily changed. Moreover, the additional part has the abutting surface that extends along the outer surface of the last body, and thus, the additional part can be easily arranged at a predetermined fixing position on the outer surface of the last body by putting the abutting surface and the outer surface of the last body together.

According to a third aspect, in the second aspect, the additional part is configured to cause at least one of a size, a width, an instep height, and a height of an arch part of the last to be different from that of standard foot model.

According to the third aspect, at least one of the size, the width, the instep height, and the height of the arch part of the last can be easily changed only by fixing the additional part to the predetermined fixing position on the outer surface of the last body.

According to a fourth aspect, in the second aspect, the additional part is formed to have a thickness that reduces toward an outer edge.

According to the fourth aspect, by forming the additional part such that the thickness thereof reduces toward the outer edge thereof, the outer surface of the last body and a surface of the additional part can be caused to be smoothly continuous (without a step generated) when the additional part is fixed in a state where the additional part abuts on the outer surface of the last body. Accordingly, according to the fourth aspect, the last that has a smooth outer surface shape without a step thereon and is close to a foot model of a person can be provided.

According to a fifth aspect, in any one of the second to fourth aspects, the additional part is formed by a 3D printer.

According to the fifth aspect, the additional part is formed by a 3D printer, so that the additional part having a complex shape can be easily and accurately formed.

According to a sixth aspect, in the first aspect, the last body is formed of a first member at a medial side and a second member at a lateral side, and the additional part is configured to change the outer surface shape of the last to a shape with a larger width than that of the standard foot model by fixing the additional part to the first member and the second member in a state where the additional part is interposed between the first member and the second member.

According to the sixth aspect, the last body is formed of two members, that is, the first member at the medial side and the second member at the lateral side, and the additional part is fixed in a state where the additional part is interposed between the two members of the last body to thus change the outer surface shape of the last to a shape with a larger width than that of the standard foot model from a fore end to a rear end. According to the additional part described above, the outer surface shape of the last can be easily changed to a shape with a larger width than that of the standard foot model from the fore end to the rear end. Moreover, by configuring the last body of two members, the additional part can be easily assembled to the last body, and therefore, change of the outer surface shape of the last can be easily performed.

### ADVANTAGES OF THE INVENTION

As has been described above, according to the present disclosure, a last in accordance with a foot shape and a request of each customer can be easily and inexpensively provided.

### BRIEF DESCRIPTION OF THE DRAWINGS

FIG. 1 is a perspective view of a last according to a first embodiment.

FIG. 2 is an exploded perspective view of the last of FIG. 1.

FIG. 3 is a perspective view of a last according to a second embodiment.

FIG. 4 is an exploded perspective view of the last of FIG. 3.

FIG. 5 is a perspective view of a last according to a third embodiment.

FIG. 6 is an exploded perspective view of the last of FIG. 5.

FIG. 7 is a perspective view of a last according to a fourth embodiment.

FIG. 8 is an exploded perspective view of the last of FIG. 7.

FIG. 9 is a perspective view of a last according to a fifth embodiment.

FIG. 10 is an exploded perspective view of the last of FIG. 9.

FIG. 11 is a perspective view of a last according to a sixth embodiment.

FIG. 12 is an exploded perspective view of the last of FIG. 11.

### DETAILED DESCRIPTION

Embodiments of the present disclosure will be described below in detail with reference to the accompanying drawings. The following embodiments are mere examples by nature, and are not intended to limit the scope of applications or uses of the present disclosure.

### First Embodiment

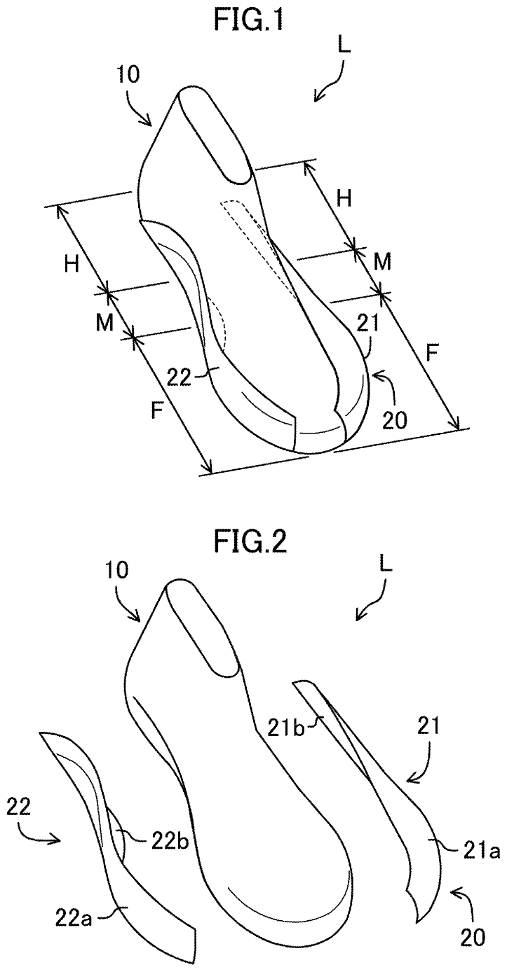

FIG. 1 and FIG. 2 are a perspective view and an exploded perspective view illustrating a last L for a left foot of lasts L according to a first embodiment of the present disclosure. Note that, since a last L for a right foot is configured to be symmetrical to the last L for a left foot, description of the last L for a right foot is omitted and only the last L for a left foot illustrated in FIG. 1 and FIG. 2 will be described in the following description. In the following description, the terms “fore (front” and “rear (hind)” represent a positional relationship in a foot length direction of the last L, and the terms “medial side” and “lateral side” represent a positional relationship in a foot width direction of the last L. Furthermore, in the following description, parts of the last L corresponding to a forefoot, a midfoot, and a rearfoot of a foot of a person will be referred to as a forefoot F, a midfoot M, and a rearfoot H.

As illustrated in FIG. 1 and FIG. 2, the last L includes a last body 10 and an additional part 20 that is fixed to the last body 10.

### Last Body

The last body 10 is configured to have an outer surface shape corresponding to a predetermined standard foot model. Note that the predetermined standard foot model refers to a relatively small foot model selected from various foot models (various foot models among which at least one of a size (foot length), a width (foot width), and a girth (foot girth) differs) assumed for each shoe size (for example, every 1 cm). In the first embodiment, the last body 10 is configured to have an outer surface shape corresponding to a standard foot model in size 25 cm. Specifically, in the first embodiment, for the size 25 cm, two types, that is, 25 cm and 25.5 cm, are assumed as types with different sizes and ten types of A, B, C, D, E, 2E, 3E, 4E, F, and G are assumed as types with different width and girth, and a foot model a size of which is 25 cm and a width and a girth of which are of A (a smallest foot model among foot models of the assumed 20 types) is a standard foot model of 25 cm. That is, in the first embodiment, the last body 10 is configured to be in size 25 cm and have an outer surface with a width and a girth of A.

For the last body 10, a material with a relatively high hardness, that is, for example, a resin with a relatively high hardness, such as, for example, polyamide (PA), polyethylene (PE), polyurethane (PU), or the like, a metal, such as aluminum (AL) or the like, a wood, or the like can be used. Note that a material of the last body 10 is not limited thereto, and any material may be used as long as the material that develops a strength with which the last body 10 is not deformed during forming of an upper.

### Additional Part

The additional part 20 changes the outer surface shape of the last L to a different shape from that of the standard foot model (the outer surface shape of the last body 10) by fixing the additional part 20 to the last body 10. In the first embodiment, the additional part 20 is configured such that, by fixing the additional part 20 to the last body 10 in a state where the additional part 20 abuts on the outer surface of the last body 10, the width of the last L is increased to a larger width than that of the standard foot model and a height of an arch part of the last L is reduced to a smaller height of the arch part than that of the standard foot model. Specifically, as illustrated in FIG. 1 and FIG. 2, the additional part 20 is configured of two side parts 21 and 22, that is, a lateral-side side part 21 and a medial-side side part 22.

The lateral-side side part 21 extends along a lateral-side end part of the last body 10 in a longitudinal direction and has a front surface 21a and a back surface 21b each being formed of a curved surface. The front surface 21a forms a portion of the outer surface of the last L. The back surface 21b is formed in a shape that extends along a portion of the outer surface of the last body 10 where the lateral-side side part 21 is fixed. The back surface 21b serves as an abutting surface that abuts on the outer surface of the last body 10 at a fixing position during fixing of the lateral-side side part 21 to the last body 10.

The medial-side side part 22 extends along a medial-side end part of the last body 10 the longitudinal direction and has a front surface 22a and a back surface 22b each being formed of a curved surface. The front surface 22a forms a portion of the outer surface of the last L. The back surface 22b is formed in a shape that extends along a portion of the outer surface of the last body 10 where the medial-side side part 22 is fixed. The back surface 22b serves as an abutting surface that abuts on the outer surface of the last body 10 at a fixing position during fixing of the medial-side side part 22 to the last body 10.

Note that the term “each of the back surfaces 21b and 22b of the side parts 21 and 22 has a shape that extends along a portion of the outer surface of the last body 10” includes not only a case where each of the back surfaces 21b and 22b has the same shape as that of a corresponding portion of the outer surface of the last body 10 but also a case where the shape allows each of the back surfaces 21b and 22b to abut on the corresponding portion of the outer surface of the last body 10 at the predetermined fixing position by bending a corresponding one of the back surfaces 21b and 22b or the like. In the first embodiment, each of the back surfaces 21b and 22b of the side parts 21 and 22 is formed in the same shape as that of a corresponding portion of the outer surface of the last body 10 on which a corresponding one of the back surfaces 21b and 22b abuts at the predetermined fixing position.

In the first embodiment, each of the two side parts 21 and 22 extends from a forefoot F to a rearfoot H of the last body 10. More specifically, in the first embodiment, each of the two side parts 21 and 22 extends from a toe part to a heel part.

The lateral-side side part 21 is formed in a shape in which a thickness thereof increases (a distance between the front surface 21a and the back surface 21b increases) around an intermediate point in the forefoot F in the longitudinal direction such that the width of the last L is larger than that of the standard foot model. The medial-side side part 22 is formed in a shape in which a thickness thereof increases (a distance between the front surface 22a and the back surface 22b increases) around an intermediate point in a midfoot M in the longitudinal direction such that the height of the arch part of the last L is smaller than that of the standard foot model.

Moreover, each of the two side parts 21 and 22 is formed such that a thickness thereof reduces toward a corresponding outer edge (a boundary of a corresponding one of the front surfaces 21a and 22a and a corresponding one of the back surfaces 21b and 22b). By forming each of the side parts 21 and 22 in the manner described above, the outer surface of the last body 10 and each of the front surfaces 21a and 22a of the side parts 21 and 22 can be caused to be smoothly continuous (without a step generated) when each of the side parts 21 and 22 is fixed in a state of abutting on the outer surface of the last body 10.

As a material of the two side parts 21 and 22, for example, a soft resin having a Shore A hardness of 70 or more and 90 or less can be used. Note that the material of the two side parts 21 and 22 is not limited thereto and any material that has enough flexibility to be deformed to closely contact the outer surface of the last body 10 during fixing of each of the side parts 21 and 22 to the last body 10 and, on the other hand, is not deformed during forming of an upper may be used. In the first embodiment, the two side parts 21 and 22 are formed by a 3D printer. Since the two side parts 21 and 22 are formed by the 3D printer as described above, each of the side parts 21 and 22 can be easily formed in a shape as designed even when the shapes of the side prats 21 and 22 are complex curved shapes.

As illustrated in FIG. 1, each of the two side parts 21 and 22 is fixed to the predetermined fixing position on the last body 10. The lateral-side side part 21 is fixed to the predetermined fixing position in the lateral-side end part of the last body 10 and the medial-side side part 22 is fixed to the predetermined fixing position in the medial-side end part of the last body 10. The two side parts 21 and 22 are configured such that each of the back surfaces 21b and 22b extends along the outer surface of the last body 10 and abuts thereon without a gap at a corresponding one of the predetermined fixing positions. The two side parts 21 and 22 are fixed by a fixing tool, such as an adhesive tape or the like, in a state where the back surfaces 21b and 22b abut on the outer surface of the last body 10.

Note that a tool used for fixing the additional part 20 to the last body 10 is not limited the adhesive tape and may be any tool by which the additional part 20 can be attached to and removed from the last body 10. As a tool used for fixing the additional part 20 to the last body 10, in addition to the adhesive tape, for example, a surface fastener, a resin bolt, a metal bolt, or the like can be used.

### Method For Producing Last Used For Custom-Order Shoes

Next, a method for producing the last L used for manufacturing custom-order shoes in accordance with a foot shape and a request of each customer will be described.

First, a foot model of a customer is determined by measurement, and the last body 10 a closest size to a size of the determined foot model and the additional part 20 necessary for producing the lasts L having an outer surface shape suitable for the determined foot model are selected and prepared.

For example, when the foot model of the customer is in size 25 cm and has a width and a girth thereof are of C, a smaller arch height than that of the standard foot model, and a standard instep height, the last body 10 having an outer surface shape that corresponds to the standard foot model in size 25 cm is selected and, as the additional part 20, the two side parts 21 and 22 that cause the width and the girth of the last L to be C by increasing the width of the last L to a larger width than that of the standard foot model and reducing the height of the arch part of the last L to a smaller arch height than that of the standard foot model by fixing the two side parts 21 and 22 to the last body 10 are selected.

After selecting the last body 10 and the additional part 20, the additional part 20 (herein, the two side parts 21 and 22) is fixed to the last body 10.

Specifically, each of the two side parts 21 and 22 is arranged at a predetermined fixing position along which a corresponding one of the back surfaces 21b and 22b that are abutting surfaces abuts on the outer surface of the last body 10. Then, the two side parts 21 and 22 are fixed to the last body 10 in a state where the back surfaces 21b and 22b abut on the outer surface of the last body 10 at the respective predetermined fixing positions. In the first embodiment, the two side parts 21 and 22 are fixed to the last body 10 by winding an adhesive tape around the last body 10 and the two side parts 21 and 22 arranged at the predetermined fixing positions on the outer surface of the last body 10 together.

Thus, the last L in size 25 cm and with a width and a girth of C, a smaller arch height than that of the standard foot model, and a standard instep height that is suitable for the foot model of the customer is produced.

Note that, in the production method described above, when the additional part 20 that to be selected is changed, the last L that is in the same size and has a different outer surface shape is produced. Moreover, in the production method described above, when the size of the selected last body 10 is changed, the last L in a different size is produced.

### Advantageous Effects of First Embodiment

As described above, according to the last L of the first embodiment, by fixing the additional part 20 to the last body 10 having an outer surface shape that corresponds to a predetermined standard foot model, the outer surface shape of the last L can be changed from that of the standard foot model. By configuring the last L in the above-described manner, it is made possible to configure the last L corresponding to various foot models using a single last body 10 not by producing, for various foot models assumed for each shoe size, lasts of the same number as the number of the foot models but by producing only the last body 10 corresponding to the standard foot model and producing additional parts 20 of multiple types. Therefore, as compared to a case where, for the various foot models assumed for each shoe size, lasts L of the same number as the number of the foot models are produced, time and labor and production costs required for producing the last L and a stock space for the last L can be largely reduced. Accordingly, according to the first embodiment, the last L in accordance with a foot shape and a request of each customer can be easily and inexpensively provided.

In the first embodiment, the additional part 20 is configured to change the outer surface shape of the last L by fixing the additional part 20 such that the additional part 20 abuts on the outer surface of the last body 10. According to the additional part 20 described above, the outer surface shape of the last L can be easily changed. Moreover, the additional part 20 has a corresponding one of the back surfaces 21b and 22b that serve as abutting surfaces each of which extends along the outer surface of the last body, and thus, the additional part 20 can be easily arranged at the predetermined fixing position on the outer surface of the last body by putting the abutting surfaces 21b and 22b and the outer surface of the last body 10 together.

In the first embodiment, the additional part 20 is configured to cause the width and the height of the arch part of the last L to be different from those of the standard foot model. Therefore, according to the first embodiment, the width and the height of the arch part of the last L can be easily changed only by fixing the additional part 20 to the predetermined fixing position on the outer surface of the last body 10.

In the first embodiment, the additional part 20 is formed to have a thickness that reduces toward an outer edge thereof. By forming the additional part 20 in the manner described above, the outer surface of the last body 10 and the front surfaces 21a and 22a of the additional part 20 can be caused to be smoothly continuous (without a step generated) when the additional part 20 is fixed in a state where the additional part 20 abuts on the outer surface of the last body 10. Accordingly, according to the first embodiment, the last L having a smooth outer surface shape that does not have a step thereon and is close to a foot model of a person can be provided.

In the first embodiment, the additional part 20 is formed by the 3D printer, and therefore, the additional part 20 having a complex shape can be easily and accurately formed.

### Second Embodiment

A last L of a second embodiment is different from the last L of the first embodiment in that the additional part 20 has a different structure from that of the first embodiment. Specifically, although the additional part 20 of the first embodiment is configured to change the width and the height of the arch part of the last L from those of the standard foot model by fixing the additional part 20 to the last body 10, the additional part 20 of the second embodiment is configured to change only the height of the arch part of the last L from that of the standard foot model by fixing the additional part 20 to the last body 10.

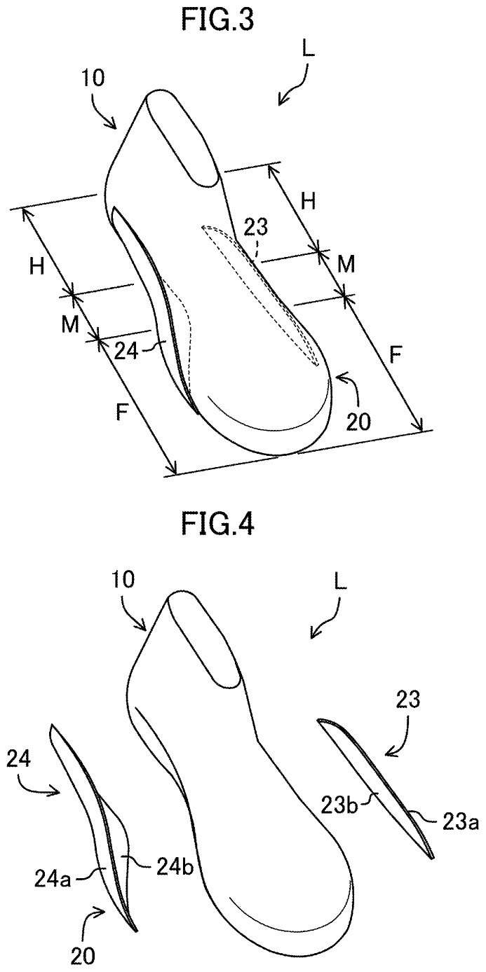

As illustrated in FIG. 3 and FIG. 4, in the second embodiment, the additional part 20 i configured of two arch parts 23 and 24, that is, a lateral-side arch part 23 and a medial-side arch part 24.

The lateral-side arch part 23 extends along the lateral-side end part of the last body 10 in the longitudinal direction and has a front surface 23a and a back surface 23b each being formed of a curved surface. The front surface 23a forms a portion of the outer surface of the last L. The back surface 23b is formed in a shape that extends along a portion of the outer surface of the last body 10 where the lateral-side arch part 23 is fixed. The back surface 23b serves as an abutting surface that abuts on the outer surface of the last body 10 at a fixing position during fixing of the lateral-side arch part 23 to the last body 10.

The medial-side arch part 24 extends along the medial-side end part of the last body 10 in the longitudinal direction and has a front surface 24a and a back surface 24b each being formed of a curved surface. The front surface 24a forms a portion of the outer surface of the last L. The back surface 24b is formed in a shape that extends along a portion of the outer surface of the last body 10 where the medial-side arch part 24 is fixed. The back surface 24b serves as an abutting surface that abuts on the outer surface of the last body 10 at a fixing position during fixing of the medial-side arch part 24 to the last body 10.

Note that the term “each of the back surfaces 23b and 24b of the arch parts 23 and 24 has a shape that extends along a portion of the outer surface of the main body 10” includes not only a case where each of the back surfaces 23b and 24b has the same shape as that of a corresponding portion of the outer surface of the last body 10 but also a case where the shape allows each of the arch parts 23 and 24 to abut on the corresponding portion of the outer surface of the last body 10 at a predetermined fixing position by bending a corresponding one of the arch parts 23 and 24 or the like. In the second embodiment, each of the back surfaces 23b and 24b of the arch parts 23 and 24 is formed in the same shape as that of a corresponding portion of the outer surface of the last body 10 on which a corresponding one of the back surfaces 23b and 24b abuts at the predetermined fixing position.

Although, similar to the two side parts 21 and 22 of the first embodiment, each of the two arch parts 23 and 24 extends from the forefoot F to the rearfoot H of the last body 10, each of the arch parts 23 and 24 extends in the longitudinal direction with the midfoot M centered and has a smaller length than a corresponding one of the side parts 21 and 22 of the first embodiment in the longitudinal direction.

In particular, the lateral-side arch part 23 has a much shorter length in the longitudinal direction than the lateral-side side part 21 of the first embodiment and is formed to have such a length in the longitudinal direction that, at the predetermined fixing position, a fore end thereof is positioned in middle of the forefoot F in rear of the toe part of the last body 10 and a rear end thereof is positioned in middle of the rearfoot H in front of the heel part. On the other hand, the medial-side arch part 24 is formed to have such a length in the longitudinal direction that, at the predetermined fixing position, a fore end thereof is positioned in middle of the forefoot F in rear of the toe part of the last body 10, but a rear end thereof is positioned in the heel part.

In the second embodiment, the two arch parts 23 and 24 are formed to cause the height of the arch part of the last L to be smaller than that of the standard foot model by fixing each of the arch parts 23 and 24 to the outer surface of the last body 10. Specifically, similar to the medial-side side part 22 of the first embodiment, the medial-side arch part 24 is formed in a shape in which a thickness thereof increases (a distance between the front surface 24a and the back surface 24b increases) around an intermediate point in the midfoot M in the longitudinal direction.

Moreover, similar to the two side parts 21 and 22 of the first embodiment, each of the two arch parts 23 and 24 is formed such that a thickness thereof reduces toward an outer edge (a boundary of a corresponding one of the front surfaces 23a and 24a and a corresponding one of the back surfaces 23b and 24b). By forming each of the arch parts 23 and 24 in the manner described above, the outer surface of the last body 10 and each of the front surfaces 23a and 24a of the arch parts 23 and 24 can be caused to be smoothly continuous (without a step generated) when each of the arch parts 23 and 24 is fixed in a state where each of the arch parts 23 and 24 abuts on the outer surface of the last body 10.

As a material of the two arch parts 23 and 24, a similar material to the material of the two side parts 21 and 22 of the first embodiment can be used. As for a fixing tool used for the two arch parts 23 and 24, a similar fixing tool to that in the first embodiment can be used.

Each of the other components is configured similar to a corresponding component of the two side parts 21 and 22 of the first embodiment. When, as the additional part 20 necessary for producing the last L having an outer surface shape corresponding to a foot model of a customer, the additional part 20 (the two arch parts 23 and 24) of the second embodiment is selected and the additional part 20 is fixed to the last body 10 by a similar method to that of the first embodiment, the last L suitable for the foot model of the customer in which the height of the arch part is smaller than that of the last body 10 corresponding to the standard foot model (a curve of the arch part is moderate) is produced as illustrated in FIG. 3. Similar effects to those of the first embodiment can be achieved also by the last L configured in the manner described above.

### Third Embodiment

A last L of a third embodiment is different from the last L of the first embodiment in that the additional part 20 has a different structure from that of the first embodiment. Specifically, the additional part 20 of the third embodiment is configured to change the instep height of the last L from that of the standard foot model by fixing the additional part 20 to the last body 10.

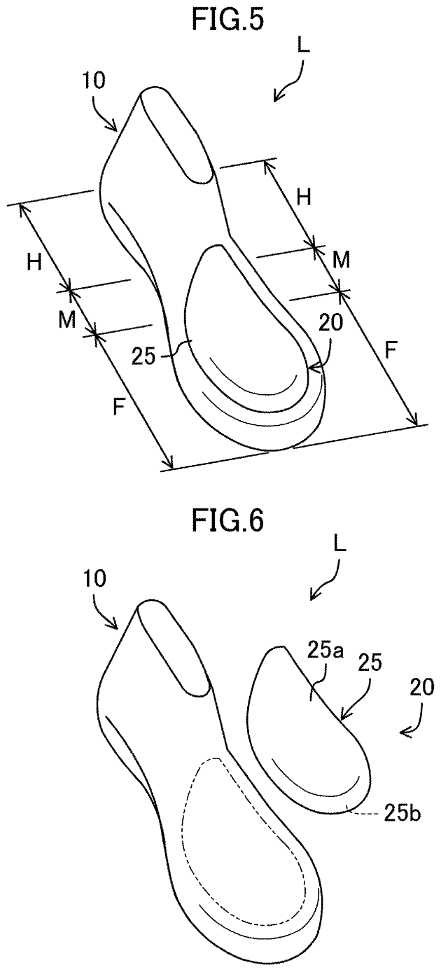

As illustrated in FIG. 5 and FIG. 6, in the third embodiment, the additional part 20 is configured of a single vamp part 25. The vamp part 25 is formed in a size that widely covers an instep part of the last body 10.

The vamp part 25 extends along the instep part of the last body 10 widely in the longitudinal direction and the width direction and has a front surface 25a and a back surface 25b each being formed of a curved surface. The front surface 25a forms a portion of the outer surface of the last L. The back surface 25b is formed in a shape that extends along the instep part of the outer surface of the last body 10 where the vamp part 25 is fixed. The back surface 25b serves as an abutting surface that abuts on the outer surface of the last body 10 at a fixing position during fixing of the vamp part 25 to the last body 10.

Note that the term “the back surface 25b of the vamp part 25 has a shape that extends along the instep part of the last body 10” includes not only a case where the back surface 25b has the same shape as that of the instep part of the last body 10 but also a case where the shape allows the vamp part 25 to abut on the instep part of the last body 10 at a predetermined fixing position by bending the vamp part 25 or the like. In the third embodiment, the back surface 25b of the vamp part 25 is formed in the same shape as that of a corresponding portion of the outer surface of the last body 10 on which the back surface 25b abuts at the predetermined position.

The vamp part 25 is formed to cause the height of the instep part of the last L to be larger than that of the standard foot model by fixing the vamp part 25 to the instep part of the last body 10. Similar to the two side parts 21 and 22 of the first embodiment, the vamp part 25 is formed such that a thickness thereof reduces toward an outer edge thereof (a boundary of the front surface 25a and the back surface 25b). By forming the vamp part 25 in the manner described above, the outer surface of the last body 10 and the front surface 25a of the vamp part 25 can be caused to be smoothly continuous (without a step generated) when the vamp part 25 is fixed in a state where the vamp part 25 abuts on the outer surface of the last body 10.

As a material of the vamp part 25, a similar material to the material of the two side parts 21 and 22 of the first embodiment can be used. As for a fixing tool used for the vamp part 25, a similar fixing tool to that in the first embodiment can be used.

Each of the other components is configured similar to a corresponding component of the two side parts 21 and 22 of the first embodiment. When, as the additional part 20 necessary for producing the last L that is suitable for a foot model of a customer, the additional part 20 (the vamp part 25) of the third embodiment is selected and the additional part 20 is fixed to the last body 10 by a similar method to that of the first embodiment, the last L suitable for the foot model of the customer in which the instep height is larger than that of the last body 10 corresponding to the standard foot model is produced as illustrated in FIG. 5. Similar effects to those of the first embodiment can be achieved also by the last L configured in the manner described above.

### Fourth Embodiment

A last L of a fourth embodiment is different from the last L of the first embodiment in that the additional part 20 has a different structure from that of the first embodiment. Specifically, the additional part 20 of the fourth embodiment is configured to change the size (foot length) of the last L from that of the standard foot model by fixing the additional part 20 to the last body 10.

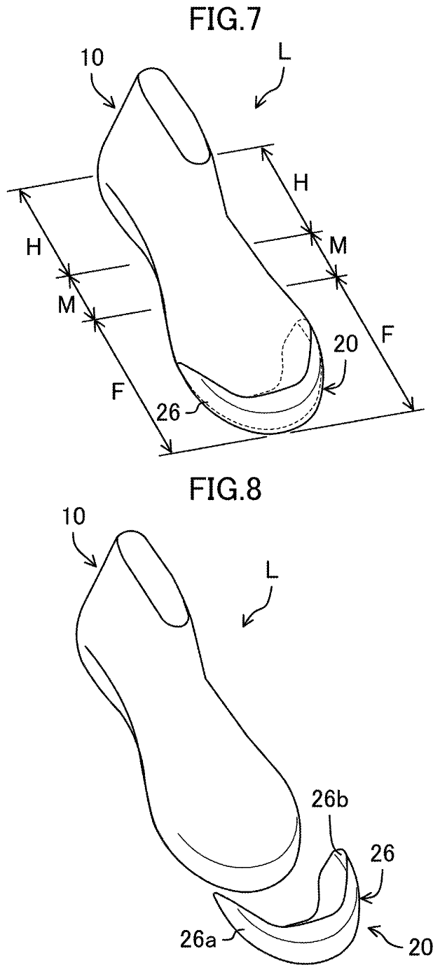

As illustrated in FIG. 7 and FIG. 8, in the fourth embodiment, the additional part 20 is configured of a single toe part 26. The toe part 26 is formed in a shape that widely covers a front side of a fore end part (toe part) of the last body 10.

The toe part 26 extends along the fore end part of the last body 10 in a curved manner in the width direction and includes a front surface 26a and a back surface 26b each being formed of a curved surface. The front surface 26a forms a portion of the outer surface of the last L. The back surface 26b is formed in a shape that extends along the fore end part (toe part) of the outer surface of the last body 10 where the toe part 26 is fixed. The back surface 26b serves as an abutting surface that abuts on the outer surface of the last body 10 at a fixing position during fixing of the toe part 26 to the last body 10.

Note that the term “the back surface 26b of the toe part 26 has a shape that extends along the fore end part of the last body 10” includes not only a case where the back surface 26b has the same shape as that of the fore end part of the last body 10 but also a case where the shape allows the toe part 26 to abut on the toe part of the last body 10 at the predetermined fixing position by bending the toe part 26 or the like. In the fourth embodiment, the back surface 26b of the toe part 26 is formed in the same shape as that of a corresponding portion of the outer surface of the last body 10 on which the back surface 26b abuts at the predetermined position.

The toe part 26 is formed to cause the size (foot length) of the last L to be larger than that of the standard foot model by fixing the toe part 26 to the fore end part of the last body 10. Similar to the two side parts 21 and 22 of the first embodiment, the toe part 26 is formed such that a thickness thereof reduces toward an outer edge thereof (a boundary of the front surface 26a and the back surface 26b). By forming the toe part 26 in the manner described above, the outer surface of the last body 10 and the front surface 26a of the toe part 26 can be caused to be smoothly continuous (without a step generated) when the toe part 26 is fixed in a state where each of the toe part 26 abuts on the outer surface of the last body 10.

As a material of the toe part 26, a similar material to the material of the two side parts 21 and 22 of the first embodiment can be used. As for a fixing tool used for the toe part 26, a similar fixing tool to that in the first embodiment can be used.

Each of the other components is configured similar to a corresponding component of the two side parts 21 and 22 of the first embodiment. When, as the additional part 20 necessary for producing the last L that is suitable for a foot model of a customer, the additional part 20 (the toe part 26) of the fourth embodiment is selected and the additional part 20 is fixed to the last body 10 by a similar method to that of the first embodiment, the last L suitable for the foot model of the customer in which the size (the foot length) is larger than that of the last body 10 corresponding to the standard foot model is produced as illustrated in FIG. 7. For example, in a case where last bodies 10 are produced such that sizes thereof differ from one another by 1 cm, when the last body 10 configured such that the size thereof is made larger than the size of the last body 10 corresponding to the standard foot model by 0.5 cm by the toe part 26 is produced, lasts L of two sizes, that is, a last L in size 25 cm and a last L in size 25.5 cm, can be produced using one last body 10 in size 25 cm. Similar effects to those of the first embodiment can be achieved also by the last L configured in the manner described above.

### Fifth Embodiment

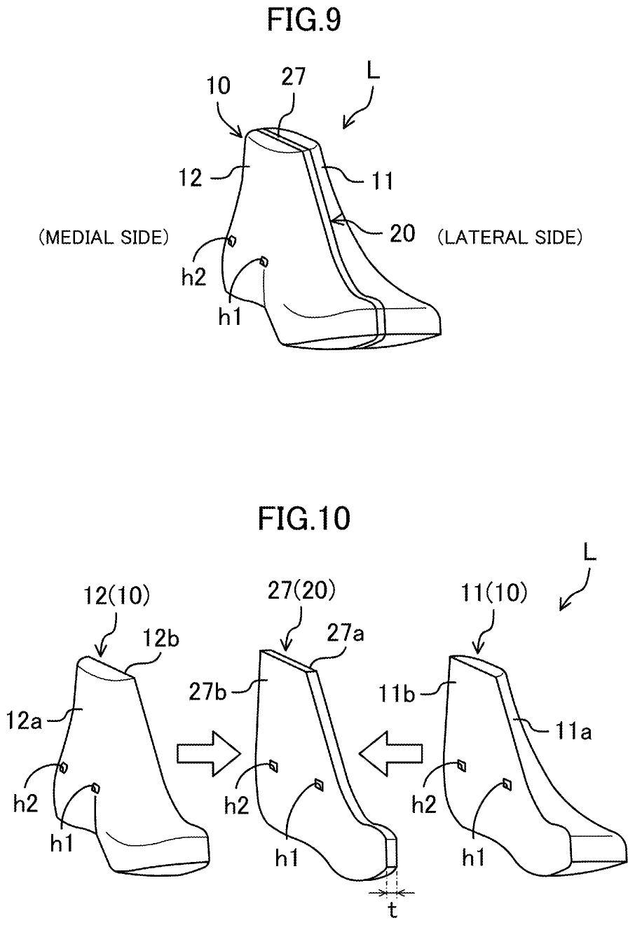

As illustrated in FIG. 9 and FIG. 10, a last L of a fifth embodiment is different from the last L of the first embodiment in that each of the last body 10 and the additional part 20 has a different structure from that of the first embodiment.

Specifically, in the fifth embodiment, the last body 10 is obtained by dividing the last body 10 of the first embodiment into two and includes a first member 11 at the lateral side and a second member 12 at the medial side. The first and second members 11 and 12 include outer surfaces 11a and 12a each serving as an outer surface of the last L and having a standard foot model shape, respectively, and inner surfaces 11b and 12b each being formed of a vertical surface extending in the longitudinal direction, respectively.

In the fifth embodiment, the additional part 20 is configured to change the width of the last L from that of the standard foot model by fixing the additional part 20 to the last body 10. Specifically, as illustrated in FIG. 9 and FIG. 10, in the fifth embodiment, the additional part 20 is configured of a single foot model plate 27.

The foot model plate 27 is formed in the same shape (foot model) as those of the inner surfaces 11b and 12b of the first and second members 11 and 12. The foot model plate 27 includes a first surface 27a at the lateral side that abuts on the inner surface 11b of the first member 11 and a second surface 27b at the medial side that abuts on the inner surface 12b of the second member 12. In the fifth embodiment, the foot model plate 27 is configured to have a constant thickness t.

The foot model plate 27 is formed to change the outer surface shape of the last L to a shape with a larger width than that of the standard foot model by fixing the foot model plate 27 to the first and second members 11 and 12 in a state where the foot model plate 27 is interposed between the inner surfaces 11b and 12b of the first sand second members 11 and 12 of the last body 10.

Similar to the material of the last body 10, as a material of the foot model plate 27, a material with a relatively high hardness, that is, for example, a resin with a relatively high hardness, such as, for example, polyamide (PA), polyethylene (PE), polyurethane (PU), or the like, a metal, such as aluminum (AL) or the like, a wood, or the like can be used. Note that, although the material of the foot model plate 27 is not limited thereto, the same material as that of the last body 10 is preferably used.

As described above, the foot model plate 27 is fixed in a state where the foot model plate 27 is interposed between the inner surfaces 11b and 12b of the first and second members 11 and 12 of the last body 10. The foot model plate 27 is fixed in a state where the first surface 27a abuts on the inner surface 11b of the first member 11 and the second surface 27b abuts on the inner surface 12b of the second member 12. In the fifth embodiment, the foot model plate 27 is fixed to each of the first and second members 11 and 12 by a metal bolt (not illustrated). Specifically, two insertion holes h1 and h2 through which the metal bolts are inserted in an inward and outward direction in each of the foot model plate 27 and the first and second members 11 and 12.

Note that a tool used for fixing the additional part 20 (the foot model plate 27) to the last body 10 is not limited to the metal bolt and any tool by which the additional part 20 can be attached and detached to and from the last body 10 may be used. As a tool used for fixing the additional part 20 to the last body 10, in addition to the metal bolt, for example, an adhesive tape, a surface fastener, a resin bolt, or the like can be used.

### Method For Producing Last Used For Custom-Order Shoes

Also in the fifth embodiment, first, a foot model of a customer is determined by measurement, and the last body 10 in a closest size to a size of the determined foot model and the additional part 20 necessary for producing the lasts L having an outer surface shape suitable for the determined foot model are selected and prepared.

For example, when the foot model of the customer is in size 25 cm and has a width and a girth of C, a larger heel width than that of the standard foot model, and standard arch height and instep height, the last body 10 having an outer surface shape that corresponds to the standard foot model in size 25 cm and being formed of the first and second members 11 and 12 is selected and, as the additional part 20, the foot model plate 27 configured to cause the width of the last L to be larger than that of the standard foot model entirely from a fore end to a rear end by fixing the foot model plate 27 to the last body 10, each of the width and the girth of the last L to be C, and the heel width thereof to be larger than that of the standard foot model is selected.

After selecting the last body 10 and the additional part 20, the additional part 20 (the foot model plate 27) is fixed to the last body 10.

Specifically, the foot model plate 27 is arranged between the first and the second members 11 and 12 of the last body 10, the first surface 27a is caused to abut on the inner surface 11b of the first member 11, and the second surface 27b is caused to abut on the inner surface 12b of the second member 12. In this state, the metal bolts are inserted through the two insertion holes h1 and h2 provided to pass through the first member 11, the foot model plate 27, and the second member 12 in the inward and outward direction to tighten the first member 11, the foot model plate 27, and the second member 12 together with the bolts or the like. Thus, the foot model plate 27 is fixed to the first and second members 11 and 12 in a state where the foot model plate 27 is interposed between the first and second members 11 and 12.

Thus, the last L in size 25 cm and with a width and a girth of C, a larger heel width than that of the standard foot model, and standard arch height and instep height is produced.

Note that, in the production method described above, when the additional part 20 that is to be selected is changed, for example, by using the foot model plate 27 with a different thickness or multiple foot model plates 27, the last L that is in the same size and has a different outer surface shape (different width, girth, and heel width) is produced. Moreover, in the production method described above, when the size of the last body 10 that is to be selected is changed, the last L in a different size is produced.

As described above, in the fifth embodiment, the last body 10 is formed of the two members 11 and 12, that is, the first member 11 at the lateral side and the second member at the medial side, and the additional part 20 is configured to change the outer surface shape of the last L to a shape with a larger width than that of the standard foot model entirely from the fore end to the rear end by fixing the additional part 20 in a state where the additional part 20 is interposed between the two members 11 and 12 of the last L. According to the additional part 20 described above, the outer surface shape of the last L can be easily changed to a shape with a larger width than that of the standard foot model. Moreover, by forming the last body 10 of the two members 11 and 12, the additional part 20 can be easily assembled to the last body 10, and therefore, change of the outer surface shape of the last L can be easily performed.

### Sixth Embodiment

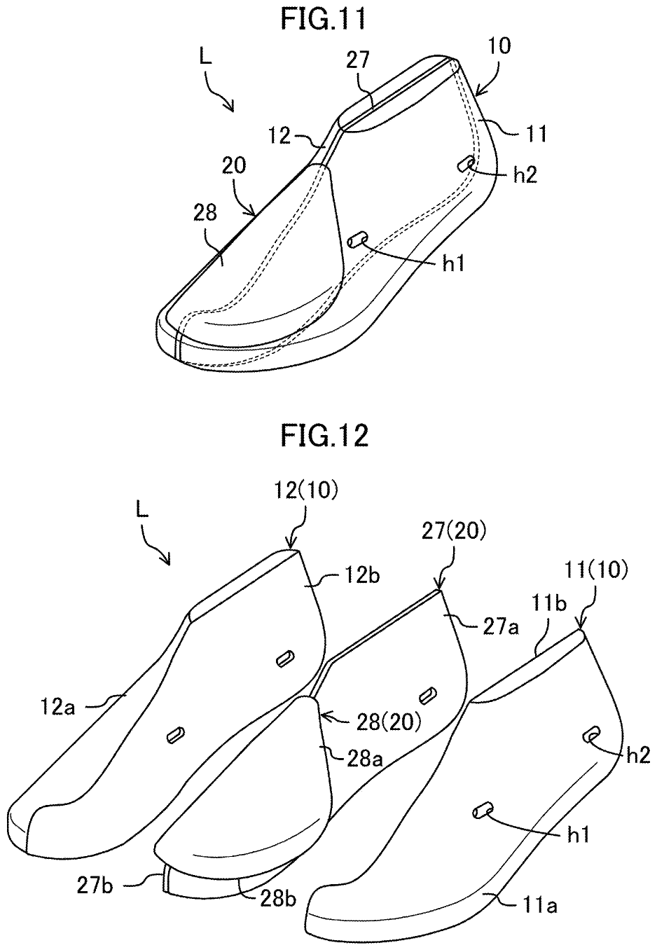

As illustrated in FIG. 11 and FIG. 12, a last L of a sixth embodiment is obtained by partially changing the structure of the additional part 20 of the last L of the fifth embodiment. Specifically, the additional part 20 of the sixth embodiment is configured to change not only the width of the last L but also the instep height from those of the standard foot model by fixing the additional part 20 to the last body 10.

As illustrated in FIG. 11 and FIG. 12, in the sixth embodiment, the additional part 20 configured of the foot model plate 27 and a vamp part 28. The vamp part 28 is formed similarly to the vamp part 25 of the third embodiment. Specifically, the vamp part 28 includes a front surface 28a that extends along the instep part of the last body 10 widely in the longitudinal direction and the width direction and is form of a curved surface that forms a portion of the outer surface of the last L and a back surface 28b formed in a shape that extends along a portion of the outer surface of the instep portion of the last body 10. The back surface 28b serves as an abutting surface that abuts on the outer surface of the last body 10 at a fixing position during fixing of the vamp part 28 to the last body 10. As illustrated in FIG. 12, in the sixth embodiment, the vamp part 28 is fixed to the foot model plate 27.

Also in the sixth embodiment, the vamp part 28 is formed to cause the height of the instep part of the last L to be larger than that of the standard foot model by fixing the vamp part 28 to the instep part of the last body 10 and a thickness thereof reduces toward an outer edge thereof (a boundary between the front surface 28a and the back surface 28b). By forming the vamp part 28 in the manner described above, the outer surface of the last body 10 and the front surface 28a of the vamp part 28 can be caused to be smoothly continuous (without a step generated) when the vamp part 28 is fixed in a state where the vamp part 28 abuts on the outer surface of the last body 10.

As a material of the vamp part 28, a similar material to the material of the vamp part 25 of the third embodiment can be used. On the other hand, in the sixth embodiment, the vamp part 28 is fixed to the foot model plate 27. The vamp part 28 and the foot model plate 27 may be fixed together after being formed, and may be integrally formed upon resin forming when each of the foot model plate 27 and the vamp part 28 is formed of resin materials (the foot model plate 27 is formed of a resin with a relatively high hardness and the vamp part 28 is formed of a soft resin).

Each of the other components is configured similar to a corresponding component in the fifth embodiment.

### Method For Producing Last Used For Custom-Order Shoes

Also in the sixth embodiment, first, a foot model of a customer is determined by measurement, and the last body 10 in a closest size to a size of the determined foot model and the additional part 20 necessary for producing the lasts L having an outer surface shape suitable for the determined foot model are selected and prepared.

For example, when the foot model of the customer is in size 25 cm and has a width and a girth of C, a larger heel width than that of the standard foot model, a standard arch height, and a larger instep height than that of the standard foot model, the last body 10 having an outer surface shape that corresponds to the standard foot model in size 25 cm and being formed of the first and second members 11 and 12 is selected and, as the additional part 20, the foot model plate 27 and the vamp part 28 that are configured to cause the width and the instep height of the last L entirely from the fore end to the rear end to be larger than those of the standard foot model to cause the width and the girth to be C, the heel width to be larger than that of the standard foot model, and the instep height of the last L to be larger than that of the standard foot model by fixing the foot model plate 27 and the vamp part 28 to the last body 10 are selected.

After selecting the last body 10 and the additional part 20, the additional part 20 (the foot model plate 27 and the vamp part 28) is fixed to the last body 10.

Specifically, the foot model plate 27 is arranged between the first and the second members 11 and 12 of the last body 10, the first surface 27a is caused to abut on the inner surface 11b of the first member 11, and the second surface 27b is caused to abut on the inner surface 12b of the second member 12. In this state, the metal bolts are inserted through the two insertion holes h1 and h2 provided to pass through the first member 11, the foot model plate 27, and the second member 12 in the inward and outward direction to tighten the first member 11, the foot model plate 27, and the second member 12 together with the bolts or the like. Thus, the foot model plate 27 is fixed to the first and second members 11 and 12 in a state where the foot model plate 27 is interposed between the first and second members 11 and 12 and the vamp part 28 is also arranged at a predetermined fixing position (the instep part) on the outer surface of the last body 10. In the sixth embodiment, the vamp part 28 is fixed to the last body 10 by winding an adhesive tape around the last body 10 together with the vamp part 28 arranged at the predetermined fixing position on the outer surface of the last body 10.

Thus, the last L in size 25 cm and with a width and the girth of C, a larger heel width than that of the standard foot model, a standard arch height, and a larger instep height than that of the standard foot model is produced.

Also, in the sixth embodiment, in the production method described above, when the additional part 20 that is to be selected is changed, for example, by changing a thickness of at least one of the foot model plate 27 and the vamp part 28, the last L that is in the same size and has a different outer surface shape (different width, girth, and heel width) is produced. Moreover, in the production method described above, when the size of the last body 10 that is to be selected is changed, the last L in a different size is produced.

As described above, also in the sixth embodiment, similar effects to those of the fifth embodiment can be achieved and also similar effects to those of the third embodiment can be achieved.

### Other Embodiments

In the first embodiment, the width and the height of the arch part of the last L are changed using the two side parts 21 and 22 as the additional part 20, in the second embodiment, the height of the arch part of the last L is changed using the two arch parts 23 and 24 as the additional part 20, in the third embodiment, the instep height of the last L is changed using the vamp part 25 as the additional part 20, in the fourth embodiment, the size (foot length) of the last L is changed using the toe part 26 as the additional part 20, in the fifth embodiment, the width of the last L is changed using the foot model plate 27 as the additional part 20, and in the sixth embodiment, the width and the instep height of the last L are changed using the foot model plate 27 and the vamp part 28 as the additional part 20.

However, the additional part 20 may be any additional part that can cause at least one of the size, the width, the instep height, the height of the arch part of the last L to be different from that of the standard foot model and is not limited to those of the first to sixth embodiments.

For example, the additional part 20 that is obtained by forming the two side parts 21 and 22 of the first embodiment short in the longitudinal direction and is configured to change only the width of the last L may be used.

The two side parts 21 and 22 of the first embodiment or the two arch parts 23 and 24 of the second embodiment may be combined with at least one of the vamp part 25 of the third embodiment and the toe part 26 of the fourth embodiment and thus be used as the additional part 20.

Furthermore, with the last body 10 configured as a split structure, the foot model plate 27 of the fifth embodiment may be combined with the two side parts 21 and 22 of the first embodiment or the two arch parts 23 and 24 of the second embodiment and thus be used as the additional part 20 and, similarly, with the last body 10 configured as a split structure, the foot model plate 27 of the fifth embodiment may be combined with the toe part 26 of the fourth embodiment and thus be used as the additional part 20.

The two side parts 21 and 22 of the first embodiment or the two arch parts 23 and 24 of the second embodiment may be combined with at least one of the vamp part 25 of the third embodiment and the toe part 26 of the fourth embodiment and, furthermore, with the last body 10 configured as a split structure, the foot model plate 27 of the fifth embodiment may be further combined with a combined body of the two side parts 21 and 22 or the two arch parts 23 and 24 and thus be used as the additional part 20.

As described above, by using, as the additional part 20, the various parts 21 to 28 in combination and also changing the combination, the lasts L with various shapes can be produced using a single last body 10. Accordingly, a last in accordance with a foot shape and a request of each customer can be easily and inexpensively provided.

In the first to fourth embodiments, each of the back surfaces 21b to 26b of the additional parts 20 (the side parts 21 and 22, the arch parts 23 and 24, the vamp part 25, and the toe part 26) is formed in the same shape as that of a corresponding portion of the outer surface of the last body 10 on which the additional part 20 abuts at a corresponding predetermined fixing position.

However, as described above, each of the back surfaces 21b to 26b of the additional parts 20 may not have the same shape as that of the corresponding portion of the outer surface of the last body 10 on which the additional part 20 abuts at the corresponding predetermined position.

Since each of the additional parts 20 is formed of a soft resin, for example, even when the additional part 20 formed in the same shape as that of a corresponding portion of the outer surface of the last body 10 in size 25 cm is used as the additional part 20 for the last body 10 having a size of 26 cm, a corresponding one of the back surfaces 21b to 26b can be caused to abut on the outer surface of the last body 10 by bending the additional part 20 or the like. According to the configuration described above, the additional parts 20 can be shared for difference sizes, and therefore, the number of additional parts 20 can be reduced. Accordingly, time and labor, costs, and a stock space for producing not only the last body 10 but also additional part 20 can be reduced.

In the fifth and sixth embodiments, the foot model plate 27 is configured to have a constant thickness t, but the foot model plate 27 may have a thickness that varies in the longitudinal direction. For example, the foot model plate 27 may have a thickness that uniformly reduces from the fore end to the rear end. Note that the first surface 27a and the second surface 27b of the foot model plate 27 and the inner surfaces 11b and 12b of the first and second members 11 and 12 of the last body 10 are configured to be abuttable.

In the first to sixth embodiments, a foot model in smallest size and with smallest width and girth (for example, a foot model in size 25 cm and of type A) is selected from various foot models (various foot models among which at least one of a size (foot length), a width (foot width), and a girth (foot girth) differs) assumed for each shoe size (for example, every 1 cm) and an example in which the last body 10 is produced using the selected foot model as the standard foot model has been described. As the standard foot model, it is preferable to select the foot model in smallest size and with smallest width and girth as described above, but the standard foot model is not limited thereto. Any foot model in relatively small size whose outer surface shape can be changed by fixing the additional part 20 among various foot models assumed for each shoe size can be used as the standard foot model.

Specifically, as in the first to sixth embodiments, when foot models of twenty types (two types with different sizes and ten types with different width and girth) are assumed for size 25 cm, for example, a foot model in size 25 cm and with width and girth of B, C, D, E, 2E, 3E, 4E, or F may be used as the standard foot model. Moreover, like a case where a foot model in smallest size and with smallest width and girth (foot model in size 25 cm and of type A) may be used as a standard foot model 1 and a foot model in smallest size and with medium width and girth (for example, foot model in size 25 cm and of type 2E) is used as a standard foot model 2, or the like, foot models of multiple types may be selected from various foot models assumed for each size and be used as the standard foot models.

The number of types of foot models assumed as types with different sizes is not limited to two and may be three or more. For example, when four sizes, that is, 25 cm, 25.25 cm, 25.5 cm, and 25.75, are assumed as types with different sizes for size 25 cm and the ten types described above are assumed as types with different width and girth, a foot model not only a width and a girth of which are medium but also a size of which is medium (in the case described above, a foot model in size 25.5 cm and of type 2E or the like) among foot models of 40 types can be used as the standard foot model. Similarly, the number of types of foot models assumed as types with different width and girth is not limited to ten.

### INDUSTRIAL APPLICABILITY

As has been described above, the present disclosure is useful for a last used for manufacturing shoes.

### DESCRIPTION OF REFERENCE CHARACTERS

L Last
10 Last body
11 First member
12 Second member
20 Additional part
21 Lateral-side side part (additional part)
21b Back surface (abutting surface)
22 Medial-side side part (additional part)
22b Back surface (abutting surface)
23 Lateral-side arch part (additional part)
23b Back surface (abutting surface)
24 Medial-side arch part (additional part)
24b Back surface (abutting surface)
25 Vamp part (additional part)
25b Back surface (abutting surface)
26 Toe part (additional part)
26b Back surface (abutting surface)
27 Foot model plate (additional part)
28 Vamp part (additional part)
28b Back surface (abutting surface)

What is claimed is:

1. A last used for forming an upper of a shoe, the last comprising:
a last body having an outer surface shape corresponding to a predetermined standard foot model; and
an additional part that changes the outer surface shape of the last to a different shape from a shape of the standard foot model by fixing the additional part to the last body.

2. The last of claim 1, wherein
the additional part has an abutting surface extending along an outer surface of the last body and is configured to change the outer surface shape of the last to a different shape from that of the standard foot model by fixing the additional part to the last body in a state where the abutting surface abuts on the outer surface of the last body.

3. The last of claim 2, wherein
the additional part is configured to cause at least one of a size, a width, an instep height, and a height of an arch part of the last to be different from that of standard foot model.

4. The last of claim 2, wherein
the additional part is formed to have a thickness that reduces toward an outer edge.

5. The last of claim 2, wherein
the additional part is formed by a 3D printer.

6. The last of claim 1, wherein
the last body is formed of a first member at a medial side and a second member at a lateral side, and
the additional part is configured to change the outer surface shape of the last to a shape with a larger width than that of the standard foot model by fixing the additional part to the first member and the second member in a state where the additional part is interposed between the first member and the second member.
